(19) United States
(12) Patent Application Publication
(10) Pub. No.: US 2026/0275801 A1
(43) Pub. Date: Sep. 17, 2026

(54) INVISIBLE WALL ELEMENT

(71) Applicant: MARTINIQUE DYNAMIQUE HOLDING, LE LAMENTIN (FR)

(72) Inventor: Vincent HITIER, LE ROBERT (FR)

(21) Appl. No.: 19/168,592

(22) PCT Filed: Mar. 28, 2024
(86) PCT No.: PCT/EP2024/058697

§ 371 Date: Sep. 24, 2025

(30) Foreign Application Priority Data
Mar. 29, 2023 (FR) 2303044

(51) Int. Cl. E06B 3/46; E05D 15/06; E05D 15/08

(52) U.S. Cl. CPC E06B 3/4654; E05D 15/0686; E05D 15/08; E06B 3/4609; E05Y 2900/14; E05Y 2900/146; E05Y 2900/148

(57) ABSTRACT

The present invention relates to a wall element (16) which is configured to be arranged around an opening (14) formed in a wall (12), the wall element (16) comprising at least one frame (20) and at least one sliding element (221, 222, 223) which is able to slide in the frame (20) in a transverse direction (T), the frame (20) comprising at least two doorframes (26a, 26b) opposite one another, each frame (26a, 26b) being configured to receive an edge (24a1, 24b1, 24a2, 24b2, 24a3, 24b3) of the at least one sliding element (221, 222, 223), the doorframes (26a, 26b) being configured such that the at least one sliding element (221, 222, 223) is translatably movable between a position wherein it covers the opening (14) and a position wherein it uncovers the opening (14), the at least one sliding element (221, 222, 223) being configured to be entirely outside a perimeter of the opening (14) in the uncovering position thereof, the doorframes (26a, 26b) each comprising an attachment support (30) which is configured to be rigidly connected to the wall (12), the attachment supports (30) being configured such that the frame (20) extends entirely outside the perimeter of the opening (14) of the wall (12), and the at least one sliding element (221) comprising a glazed panel (251) and a first edge (241) and being configured so that the first edge (241) is entirely outside the perimeter of the opening (14) in the covering position of the first sliding element (221).

### TECHNICAL FIELD OF THE INVENTION

The present invention relates to a wall element intended to cover an opening formed in a wall of a building, so that the wall element is invisible from inside the building.

### TECHNICAL BACKGROUND

Many wall elements such as frames carrying sliding parts exist. Such wall elements allow covering an opening formed in a wall, of a dwelling, for example, to insulate it thermally and/or acoustically and/or sound-proof it. Notably, when the frame is intended to carry a sliding window, it is essential that the wall element allows the passage of light.

Despite the presence of many wall elements on the market, these have functionalities that are substantially identical to each other and increasingly complex assemblies.

Making an opening fully accessible from the inside when a sliding wall element is in the open position is known from U.S. Pat. No. 4,057,937A.

Furthermore, FR2970728A1 discloses a wall element whose sliding parts can be dismantled by pivoting the sliding part relative to a frame of the wall element.

However, these materials have complex structures that are not aesthetic from inside the building and are of limited usage functionalities.

Thus, there is a real need to propose new alternatives to existing wall elements, to offer a device that is both simple in its design and installation but also aesthetic and flexible.

### SUMMARY OF THE INVENTION

The invention proposes a wall element as defined in claim 1.

By means of the invention, the wall element is functional while being more aesthetic by being imperceptible from one side of the opening.

Moreover, the device proposed by the invention offers new functionalities to wall elements intended to cover an opening formed in a wall by not being limited only to thermal or acoustic insulation and sound-proofing functions. Thus, the wall element proposed by the invention facilitates assembly around an opening on any existing wall, while significantly increasing the number of beams of light able to pass through the opening while being imperceptible from one side of the opening from an internal space of the dwelling, for example.

Additionally, the wall element proposed by the invention offers new functionalities through the presence of a modular sliding part.

Other features of the invention are set out in claims 2 to 13.

The invention also relates to an assembly as defined in claim 14.

One advantageous feature of the assembly is set out in claim 15.

### BRIEF DESCRIPTION OF THE FIGURES

Other features and advantages of the invention will appear when reading the detailed description that follows, for the understanding of which reference will be made to the appended drawings, wherein:

FIG. 1 is a general perspective view of an assembly according to the invention comprising a wall element attached to a wall around an opening, the wall element comprising a frame and sliding elements;

FIG. 2 is a front view of the wall element of FIG. 1 showing the sliding elements moving from a covering position to a position wherein it uncovers the opening;

FIG. 3 is a schematic sectional view in a longitudinal and vertical plane of the wall element, one of the sliding elements of which comprises a tray, which is able to pivot around a rotation axis at least partially inside the opening of the wall;

FIG. 4 is a sectional view in a longitudinal and vertical plane of a doorframe of the wall element of FIG. 1 comprising an attachment support, an intercalary element, a covering portion, and a sliding device according to a first example of the invention;

FIG. 5 is a perspective view of the sliding device of FIG. 4;

FIG. 6 is a sectional view in a longitudinal and vertical plane of a doorframe of the wall element wall element of FIG. 1 comprising a sliding device according to a second mode of the invention;

FIG. 7 is a view of a part of a roller carriage of the sliding device of FIG. 6;

FIG. 8 is a front view of the attachment support of one of the doorframes of the wall element of FIG. 1 according to a third embodiment;

FIG. 9 is an exploded perspective view of one of the doorframes of the wall element of FIG. 1 according to a fourth embodiment of the invention;

FIG. 10 is a front view of the wall element of FIG. 1 showing the sliding elements according to a fifth embodiment of the invention;

FIG. 11 is a general front view of the wall element showing a pivoting tray according to a sixth embodiment of the invention, with inserts (A) and (B) showing the tray in different positions;

FIG. 12 is a view similar to FIG. 11 for a seventh embodiment of the invention;

FIG. 13 is a view similar to FIG. 11 for an eighth embodiment of the invention;

FIG. 14 is a top view of the wall element of FIG. 13, with inserts (A) and (B) corresponding to the positions of the tray in the respective inserts (A) and (B) of FIG. 13.

### DETAILED DESCRIPTION OF THE INVENTION

For the description of the invention and understanding the claims, the vertical, longitudinal, and transverse orientations will be adopted as non-limiting and without reference to terrestrial gravity according to the V, L, T reference indicated in the figures, with the longitudinal L and transverse T axes extending in a horizontal plane. By convention, the longitudinal axis L is oriented from back to front.

In the following description, identical, similar, or analogous elements will be designated by the same reference numbers.

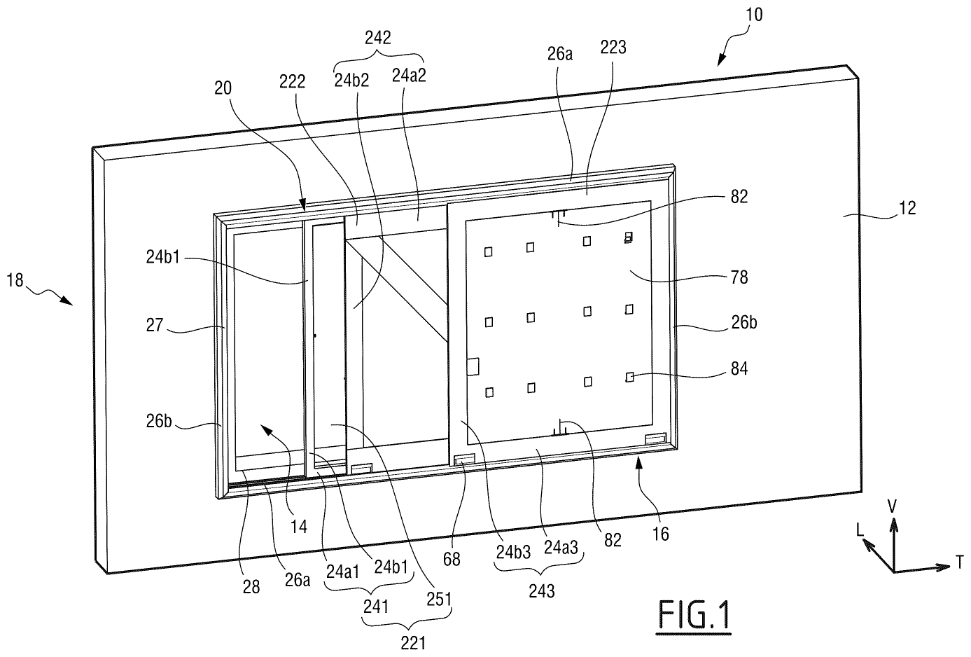

FIG. 1 illustrates an assembly 10 comprising a wall 12 with an opening 14 and a wall element 16.

The wall 12 may be that of a dwelling and defines an internal space 18 within the dwelling. The opening 14 then allows the passage of light into the internal space 18 of the dwelling, also called the living space.

The wall element 16 comprises at least one frame 20 wherein at least one sliding element 22 extends, here a first sliding element 221, a second sliding element 222, and a third sliding element 223. The sliding elements 221, 222, 223 are notably able to slide transversely in the frame 20.

It should also be considered, in a non-limiting and non-illustrated manner, that the frame could be configured so that the sliding elements are able to slide vertically in it.

According to the illustrated example of the invention, and in a non-limiting manner, the first sliding element 221 is glazed, the second sliding element 222 is a shutter, and the third sliding element 223 is a trim. Notably, as clearly visible in FIG. 1, the first sliding element 221 comprises a first edge 241 and a preferably transparent glazed panel 251.

Thus, relative to the internal space 18 of the dwelling, the sliding elements are superimposed so that the second sliding element 222 covers the first sliding element 221 and the third sliding element 223 covers the second sliding element 222.

As visible in FIG. 1, each of the sliding elements has a rectangular shape delimited by four edges. Horizontal edges 24a1, 24a2, and 24a3 of the sliding elements 221, 222, and 223 are defined, extending in the transverse direction T and opposite one another in the vertical direction V, and lateral or vertical edges 24b1, 24b2, and 24b3 of the sliding elements 221, 222, and 223, extending in the vertical direction V and opposite one another in the transverse direction T. The horizontal edges 24a1, 24a2, and 24a3 constitute crosspieces, and the lateral or vertical edges 24b1, 24b2, and 24b3 constitute uprights for the sliding elements 221, 222, and 223.

The frame 20 according to the illustrated example of the invention comprises four doorframes delimiting a receiving and sliding space for each of the sliding elements 221, 222, and 223. Two horizontal doorframes 26a are defined, extending in the transverse direction T and opposite one another in the vertical direction V, and two lateral or vertical doorframes 26b, extending in the vertical direction V, opposite one another in the transverse direction T, and connecting the vertical doorframes 26a to each other.

It is then understood that the horizontal doorframes 26a are configured to receive the horizontal edges 24a1, 24a2, and 24a3 of each of the sliding elements 221, 222, and 223, and that the lateral or vertical doorframes 26b are configured to receive the lateral or vertical edges 24b1, 24b2, and 24b3 of each of the sliding elements 221, 222, and 223.

As visible in FIGS. 1, 2, 4, and 6, the doorframes 26a and 26b are arranged against the wall 12 so that the frame 20 extends around the opening 14, without being visible from the internal space 18 through the opening 14.

Thus, each of the doorframes 26a and 26b extends at a non-zero distance from a contour 28 delimiting the opening 14.

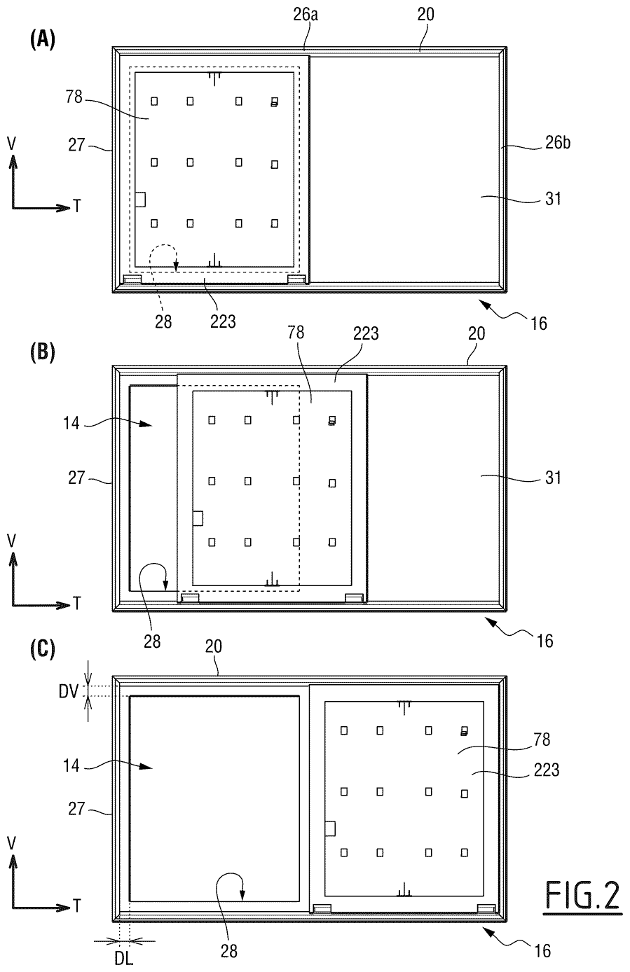

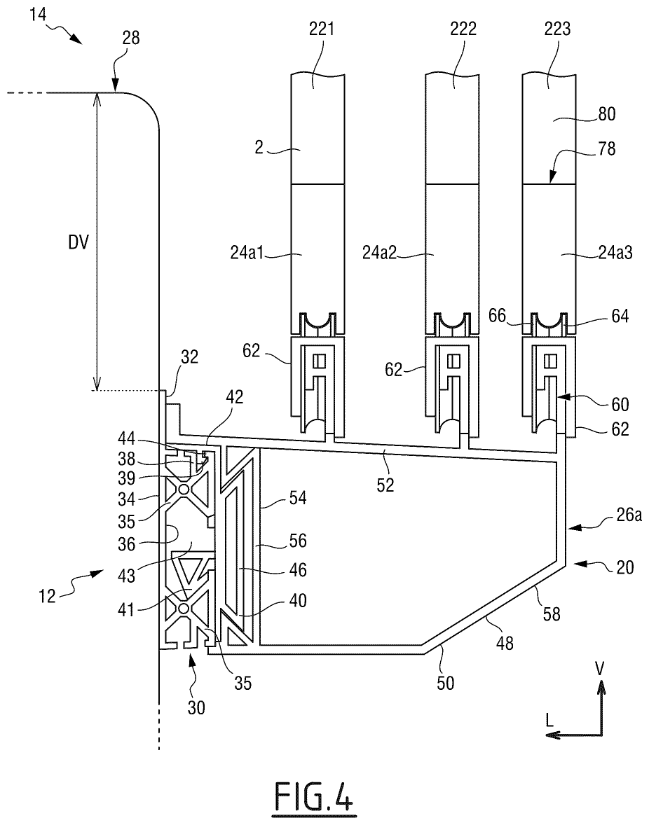

More precisely, the horizontal doorframes 26a extend at a vertical distance DV, visible in FIGS. 2 and 4, of between 10 mm and 100 mm relative to the horizontal contour 28 that delimits the opening 14 in the vertical direction V, and the lateral doorframes 26b extend at a lateral distance DL, visible in FIG. 2, of between 10 mm and 100 mm relative to the vertical contour 28 that delimits the opening 14 in the transverse direction T. The above dimensions are given as non-limiting examples.

More precisely, and in relation to FIG. 2, the frame 20 is configured to extend transversely over a greater lateral distance DL on one vertical side of the opening 14.

More particularly, the frame 20 is configured so that the sliding elements 221, 222, and 223 are translatably movable between a position wherein it covers the opening 14, visible in part A of FIG. 2, and a position wherein it uncovers the opening 14, visible in part C of FIG. 2, with the sliding elements 221, 222, and 223 being configured to be entirely outside a perimeter of the opening 14 in their uncovering position.

In the sense of the present invention, a position wherein it uncovers the opening 14 adopted by the sliding elements 221, 222, and 223 is a position wherein these sliding elements leave the opening 14 uncovered, that is, a position wherein none of these sliding elements is aligned with this opening. The uncovering position can also be called “uncovered position.”

Similarly, it is understood that to achieve the invisibility feature of the wall element 16, and as clearly visible in FIG. 1, the horizontal edges 24a1 and 24b1 of the first sliding element 221 extend entirely outside the perimeter of the opening 14 regardless of the position of the first sliding element 221, and that the entirety of the first edge 241 extends outside the perimeter of the opening 14 when the first sliding element 221 is in the covering position. In other words, the first edge 241 defines an interior space, which it surrounds and which is larger than the opening 14. Thus, the first edge 241 is invisible to a person present in the building at a certain distance from the window when the first sliding element 221 is in the covering position. In this covering position, only the glazed panel 251 of the first sliding element is visible to the person in the building at a certain distance from the window. If it is transparent, as envisaged above, this glazed panel 251 does not limit the view from inside the building.

The frame 20 according to the illustrated example of the invention delimits an uncovering zone 31, transversely adjacent to the opening 14 and configured to receive the sliding elements 221, 222, and 223 in their uncovering position and so that they are invisible through the opening 14.

In the following description, the structural and functional features of embodiments of a doorframe 26a will be described, but it is understood that these can apply to several doorframes 26a or 26b of the frame.

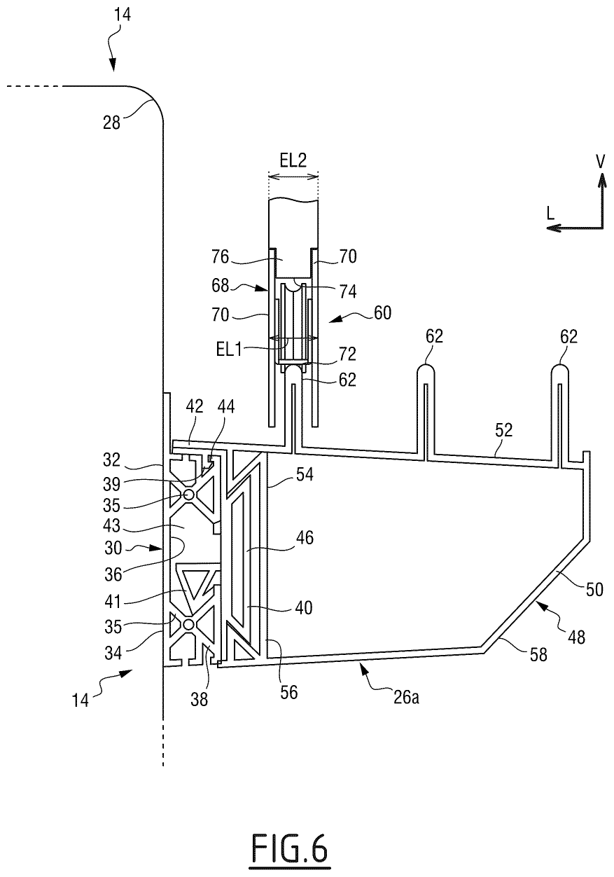

The doorframe 26a visible in FIGS. 4 and 6 comprises an attachment support 30 to the wall 12. More particularly, the attachment support 30 of the doorframe 26a is configured so that the frame 20 extends entirely outside the opening 14 of the wall 12, as visible in FIG. 1 and in FIGS. 4 and 6. In other words, the attachment support 30 of the doorframe 26 according to the example of the invention is imperceptible through the opening 14. In other words, the attachment support 30 of the doorframe 26 extends entirely outside the opening 14 of the wall 12. The attachment support 30 of the doorframe 26a according to the illustrated example of the invention in FIGS. 4 and 6 takes the form of a plate 32 comprising a contact face 34 intended to be arranged against the wall 12, and a fixing face 36, opposite the contact face 34 in the longitudinal direction L.

Fixing holes to the wall, here not visible, then pass longitudinally through the plate 32. Furthermore, a fixing member 38 having grooves 39, among other things, protrudes longitudinally from the fixing face 36 of the plate 32.

Moreover, the fixing member 38 here takes the form of a slide wherein two longitudinally protruding elements 35 delimit a receiving space 43 for hooking members 41 of another element of the doorframes 26a or 26b. It is also understood that the grooves 39 are formed on the protruding elements 35 of the fixing member 38.

The fixing member 38 may also comprise a structure reinforced by a mesh, as visible in FIGS. 4 and 6. More particularly, the two protruding elements 35 have a mesh structure.

According to another example of the attachment support 30 visible in FIG. 8, the protruding elements 35 of the fixing member 38 comprise edges 45 protruding vertically, around the receiving space 43 of the hooking members 41, so that the fixing member 38 has a toothed profile, as visible in FIG. 8.

It should also be considered that this embodiment of the attachment support 30 applies to the horizontal doorframes 26a of the frame.

Thus, the edges 45 protrude vertically from one end of each of the protruding elements 35 alternately. In other words, the edges 45 extend alternately on one or the other of the protruding elements 35 in the vertical direction V and so as to form upper edges 45a and lower edges 45b, opposed in the vertical direction V.

The advantage of such a configuration of the fixing member 38 of the attachment support 30 of FIG. 8 will be detailed later in the detailed description.

The attachment support 30 can be secured to the wall 12 by screwing through the fixing holes, for example via dowels or otherwise. It should also be considered that the attachment support 30 can be secured by any other non-limiting means, as long as it ensures the optimal securing of the attachment support to the wall.

As visible in FIGS. 4 and 6, the doorframe 26a comprises an intercalary element 40, secured to the attachment support 30.

More precisely, the intercalary element 40 comprises at least one arm 42 that extends towards the attachment support 30 and comprises a rib 44 able to interact with at least one of the grooves 39 of the fixing member 38 of the attachment support 30.

The intercalary element 40 also comprises the hooking members 41 mentioned previously and able to interact with the fixing member 38 of the attachment support 30 mentioned previously. Notably, it is understood that the hooking members 41 are able to fit into the receiving space 43 of the fixing member 38, so as to slide in the slide, along the protruding elements 35, when assembling the doorframe 26.

According to the example of the fixing member 38 of FIG. 8 described previously, the hooking members 41 are configured to interact with the fixing member 38 beforehand by a longitudinal translation in the receiving space 43, at one of the lower edges 45b, so that the hooking members 41 fit into the receiving space 43 of the fixing member 38, then by a transverse sliding of the hooking members 41 along the lower edges 45b, until the hooking members 41 fit between two lower edges 45b, so as to be locked in position in the receiving space 43 of the fixing member 38.

In other words, the transverse sliding of the intercalary element 40 moves the hooking members 41 in transverse translation until they fall vertically between two lower edges 45b and in front of one of the upper edges 45a. The hooking members 41 are then locked in position in the slide formed by the fixing member 38.

The intercalary element 40 can be made of a thermally insulating material, for example.

The intercalary element 40 also comprises a fixing tenon 46 protruding, here longitudinally, opposite the attachment support 30. The fixing tenon 46 allows dovetail fixation, for example, with a covering portion 48 of the doorframe.

The covering portion 48 has a profiled shape, here longitudinally, and comprises at least one main body 50 comprising at least one upper wall 52 and a connecting wall 54.

Notably, the upper wall 52 extends in a plane intersecting the plate 32 of the attachment support 30, and the connecting wall 54 defines a trapezoidal housing 56 of complementary shape to the fixing tenon 46 of the intercalary element 40 so as to form the dovetail fixation between the intercalary element 40 and the covering portion 48.

According to the illustrated example of the invention, a covering wall 58 extends between the free end of the upper wall 52 and the connecting wall 54, so as to connect them.

According to one feature of the illustrated example of the invention, the covering portion 48 is configured so that it entirely covers the attachment support 30 when the latter is secured to the wall. Thus, it is understood that the covering portion 48 has vertical and transverse dimensions at least equal to or greater than the attachment support 30.

It is then understood that in the covering portion 48 extends vertically and transversely over a dimension at least equal to or greater than the plate 32 of the associated attachment support 30.

Thus, in a front view of the wall element 16 along the longitudinal direction L, when it is secured to the wall 12, only the covering portions 48 are visible.

One takes advantage of the doorframe 26 as just described in that, on the one hand, the attachment supports 30 can comprise screws and other unsightly elements, for example, that are then camouflaged by the covering portion 48 and, on the other hand, in that the assembly of the covering portions 48 as just described facilitates accessibility to the attachment support 30 for maintenance operations of the wall element, for example.

It should also be considered that the doorframe 26 could comprise only the attachment support 30 and the covering portion 48, fixed to each other by dovetail fixation or any other means of fixation, allowing the sliding fixation of one in the other. For example, and in a non-limiting manner, the covering portion is fixed to the attachment support by interaction between the slide-shaped fixing member described previously, with or without the upper and lower edges, and the hooking members carried directly by the covering portion in a manner similar to what was described for the intercalary portion.

According to another non-limiting example of the invention, the covering portion is fixed to the attachment support by screwing from inside the frame.

According to another non-illustrated example of the invention, the doorframes can be monobloc. The doorframes can also be fixed to the wall from inside the frame so that the screws are inaccessible once the sliding elements are in the covering position. The fixation can be done with through screws, for example, or not, and via dowels, for example.

According to a fourth non-limiting embodiment of the invention, the frame 20 is configured so that one of the lateral doorframes 26b locks the other doorframes of the frame in position.

More particularly, and according to the fourth non-limiting embodiment of the invention, the two horizontal doorframes 26a and one of the vertical doorframes 26b conform to one of the embodiments described above and are installed against the wall by sliding as described above, and the last vertical doorframe 26b, hereinafter called the locking doorframe 27, is positioned against the wall only by longitudinal translation.

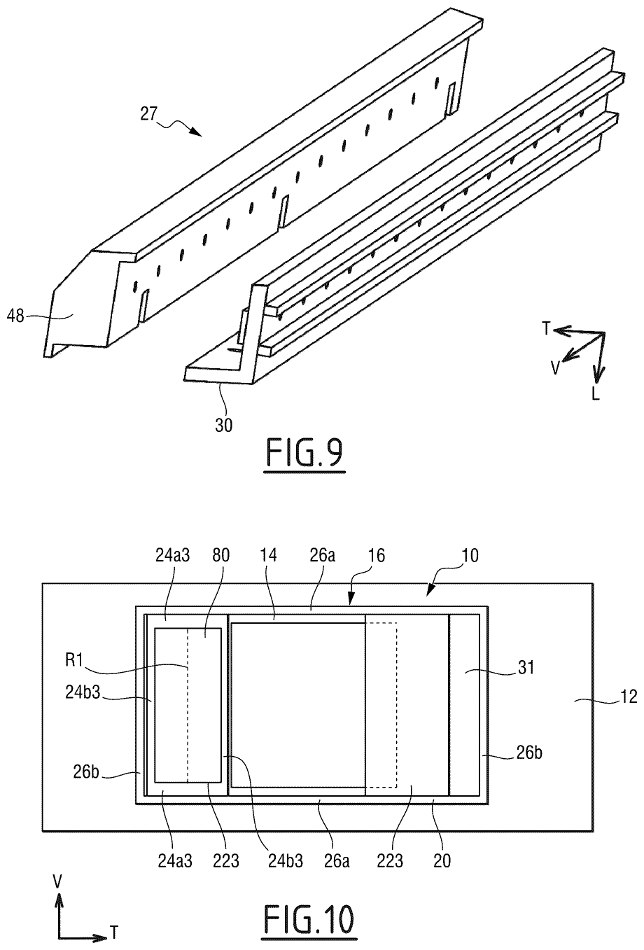

For example, and as visible in FIG. 9, the locking doorframe 27, serving to lock the other doorframes 26a and 26b of the frame in position, is formed of the attachment support 30 secured to the wall by screwing and the covering portion 48 secured to the fixing portion 30 by screwing.

In such a configuration of the locking doorframe 27, the attachment support 30 has an L-shape housing the covering portion 48 so that the covering portion 48 entirely covers the attachment support 30.

To facilitate the assembly of the covering portion 48 on the attachment support 30, fool-proofing means can be formed on these to ensure the correct position of the covering portion on the attachment support.

According to one advantageous embodiment of the locking doorframe 27, the screwing of the covering portion of the locking doorframe 27 on the attachment support 30 is done from inside the frame so that the screws are inaccessible once the sliding elements are in the covering position.

Such a configuration of the locking doorframe 27 is advantageous in that its fixation to the wall is secured once the sliding elements are in the covering position so that its detachment from the wall is impossible from the outside. The entire frame is then secured to the wall in an inviolable manner when the sliding elements are in the covering position.

To allow the translation of the sliding elements within the frame, the covering portions 48 of the horizontal doorframes 26a comprise a sliding device 60 for each of the sliding elements 221, 222, and 223.

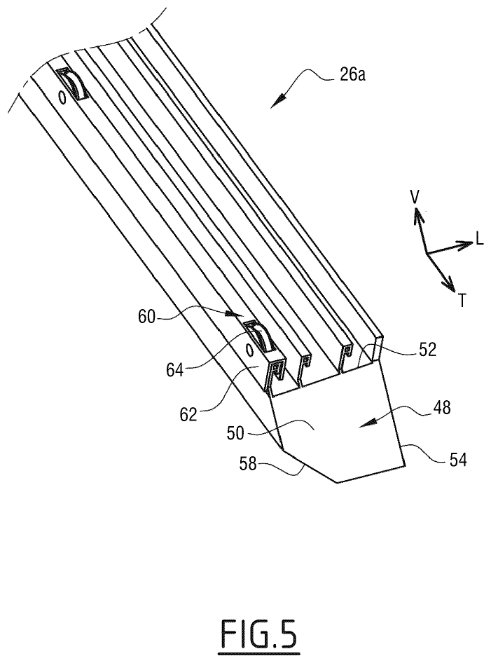

According to a first example of the invention visible in FIGS. 4 and 5, the sliding device 60 of each of the sliding elements 221, 222, and 223 comprises a raised edge 62 on which at least one roller 64 is arranged.

More precisely, the upper wall 52 of each of the covering portions 48 of the horizontal doorframes 26a comprises three raised edges 62, housing a plurality of rollers 64 in their thickness. The raised edges 62 are then spaced longitudinally from each other by a non-zero distance.

Thus, according to this first example of the invention, the lower horizontal edges 24a1, 24a2, and 24a3 of each of the sliding elements 221, 222, and 223 are configured to slide along the sliding devices 60 associated with each of the horizontal doorframes 26a.

More precisely, the horizontal edges 24a1, 24a2, and 24a3 of each of the sliding elements 221, 222, and 223 comprise a peripheral recess 66 configured to receive the raised edge 62 and the rollers 64 of the sliding devices 60 of the horizontal doorframes 26a.

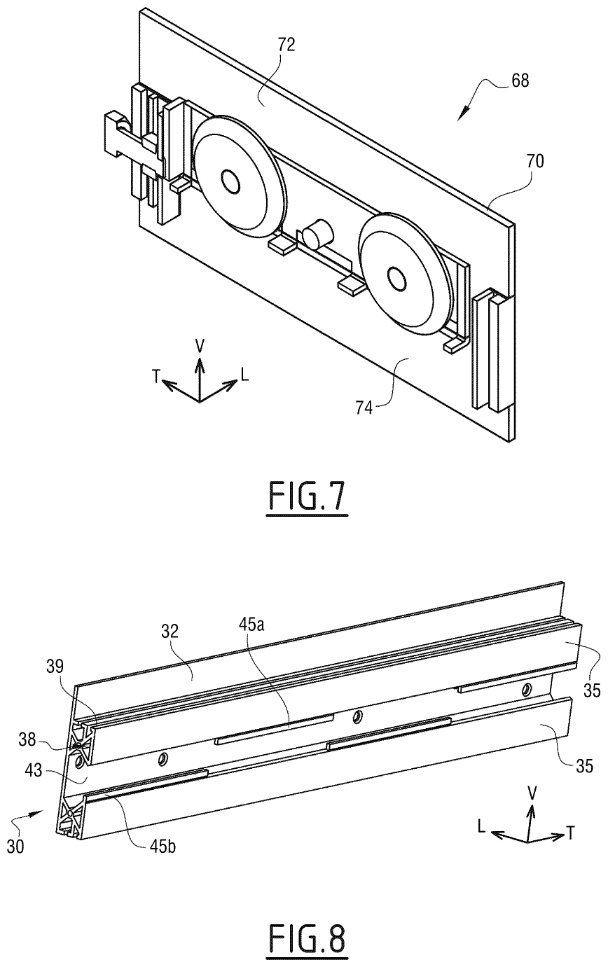

According to a second embodiment of the invention visible in FIGS. 6 and 7, the sliding device 60 of each of the sliding elements 221, 222, and 223 comprises the raised edges 62 formed in the upper wall 52 of the covering portion 48, on each of which at least one roller carriage 68, here two roller carriages 68, comes into engagement.

Thus, in the embodiment of the invention illustrated in FIGS. 6 and 7, the upper wall 52 of each of the covering portions 48 comprises the three raised edges 62 on which two respective roller carriages 68 slide.

The roller carriages 68 comprise two walls 70 delimiting at least one receiving space 72 for the rollers and a receiving zone 74 for one of the vertical edges of each of the sliding elements, the receiving space 72 and the receiving zone 74 being strictly distinct from each other.

Thus, it is understood that the receiving space 72 for the rollers is configured to house the raised edge 62 to which it is associated, and that the receiving zone 74 for one of the lower horizontal edges 24a1, 24a2, or 24a3 of an associated sliding element 221, 222, or 223 is configured to house one of the lower horizontal edges 24a1, 24a2, or 24a3 of said sliding element 221, 222, or 223.

More precisely, in this embodiment of the invention, the lower horizontal edges 24a1, 24a2, or 24a3 of each of the sliding elements 221, 222, and 223 comprise thinned portions 76 intended to fit into the receiving zones 74 of the roller carriages 68.

A thinned portion 76 of the vertical edges means a portion having a thickness, taken in the longitudinal direction L, less than a longitudinal thickness of the sliding element 221, 222, or 223, outside the thinned portion 76.

Thus, it is understood that each horizontal edge of each of the sliding elements 221, 222, and 223 comprises two thinned portions 76, transversely opposite one another, so as to fit into two distinct roller carriages 68.

Thus, a first longitudinal thickness EL1 of the roller carriages 68 and a second longitudinal thickness EL2 of the sliding elements 221, 222, and 223 are defined, outside their thinned portions 76, with the first thickness EL1 and the second thickness EL2 being substantially identical.

Additionally, the walls 70 of the roller carriages 68 extend in the extension of the sliding elements 221, 222, and 223.

Thus, one takes advantage of such a configuration of the sliding elements carried by the roller carriages 68 ensuring their translation sliding between the doorframes 26a and 26b, in that it allows maintaining a minimal thickness of the sliding elements 221, 222, and 223 and the sliding device 60 ensuring their sliding. Advantageously, the thickness of the covering portion 48, and therefore the length of the cantilevered part, is thus reduced by 1 cm per carriage compared to a solution that would not involve a thinned portion, i.e., a gain of 3 cm in total on the cantilevered part. Consequently, stress on the attachment supports 30 is also minimized. The values of 1 cm and 3 cm are mentioned above as non-limiting examples.

According to the first and second embodiments of the invention visible in FIGS. 4 and 6, the upper wall 52 of the covering portions 48 extends in a transverse T and longitudinal L plane, having an angle of between 89° and 60° relative to the plate 32 of the attachment support 30.

Such a feature is advantageous in that it allows evacuating a fluid such as rain outside the doorframes 26a and 26b by guiding the fluid opposite the attachment support 30. Notably, end gutters can be provided to allow the evacuation of the fluid outside the doorframes.

It is also understood that during the translation movement of the sliding elements 221, 222, and 223 along the horizontal doorframes 26a, as visible in FIG. 2, the vertical doorframes 26b form a translation stop for the sliding elements 221, 222, and 223.

According to the first embodiment of the invention visible in FIGS. 1 and 5, the third sliding element 223 forming the trim comprises an opening 78 wherein a tray 80 is configured to pivot around a first rotation axis R1 in the opening.

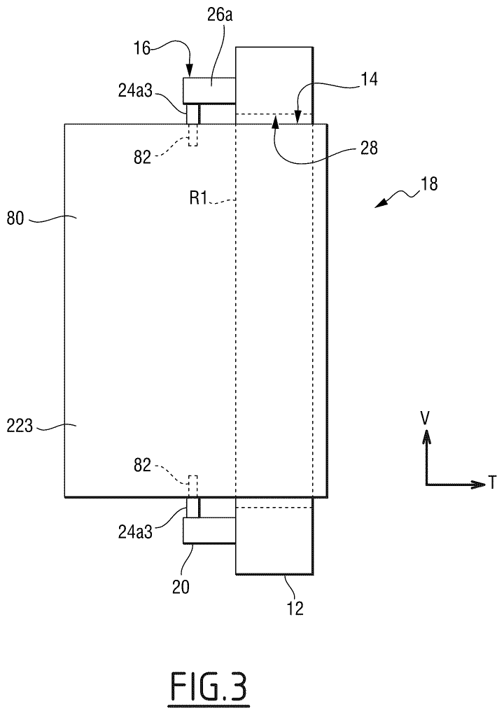

In the example illustrated in FIG. 3, the tray 80 pivots around the first rotation axis R1, which is vertical and defined by two lugs 82, each protruding from one of the horizontal edges 24a of the third sliding element 223, in the opening.

It should also be considered that the first rotation axis R1 of the tray 80 could also be horizontal. Additionally, in an unrepresented variant, the third sliding element 223 could comprise more than one opening associated with a pivoting tray. Moreover, for example, one can provide another variant wherein an opening is associated with several trays pivoting in the opening.

The tray 80 of the third sliding element 223 can then comprise fixing openings 84 for accessories such as flower pots or other elements. Advantageously, the tray 80 can comprise other fixing means such as rails or notches intended to receive rails.

Thus, it is understood that when the first sliding element 221 and the second sliding element 222 are in the uncovered position, as visible in part (C) of FIG. 2, the third sliding element 223 in its uncovered position has the function of camouflaging them, and in its covered position allows the tray 80 to be pivoted through the opening 14 of the wall 12, as visible in FIG. 3. One can thus integrate the accessories carried by the tray into the interior space of the dwelling without having to detach them from the tray, to use them inside the living space of the dwelling, for example, or in case of weather constraints.

Furthermore, it should be considered that the sliding elements can comprise invisible gripping means, housed directly in the thickness of these and turned towards the internal space of the dwelling. In this way, the gripping means are invisible and are only accessible from inside the dwelling.

According to a fifth embodiment of the invention visible in FIG. 10, each of the sliding elements 221, 222, and 223 can be made in two parts.

More particularly, in the embodiment of FIG. 10, the frame 20 delimits two uncovering zones 31 on either side of the opening 14 in the transverse direction T. Thus, it is understood that each of the two parts of the sliding elements 221, 222, and 223 is configured to slide transversely in covering one of the uncovering zones 31 delimited by the frame 20. It should also be considered that the structural and functional features of the wall element 16 described above apply mutatis mutandis to the embodiment of FIG. 10.

Thus, each of the parts of each of the sliding elements 221, 222, and 223 can take a covering or uncovering position of the opening 14 independently of each other.

Furthermore, in the case of the third sliding element 223 forming the trim, it is understood that one and/or the other of the parts of the third sliding element 223 can comprise the pivoting tray 80, as described previously.

One takes advantage of the embodiment of FIG. 10 in that it allows installing the wall element 16 around an opening 14 whose wall space in the periphery is reduced, notably in the transverse direction T. In other words, when the wall space around the opening 14 does not allow the installation of the frame comprising the uncovering zone 31 as described in FIGS. 1 and 2, the installation of the frame 20 according to the embodiment of FIG. 10 allows remedying this by distributing the covering zones 31 on either side of the opening 14 in the transverse direction T.

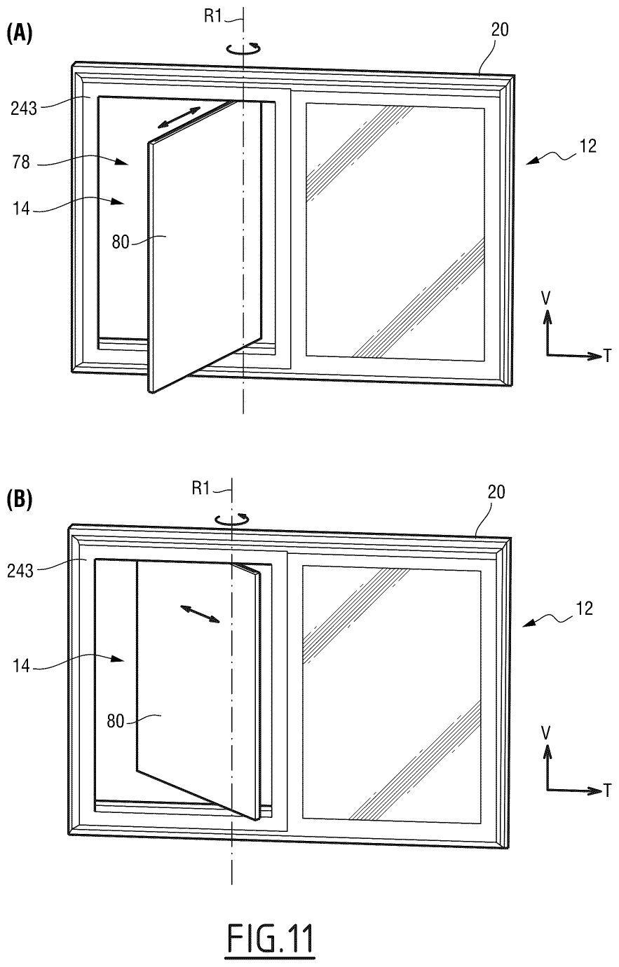

In a sixth embodiment of the invention, illustrated in FIG. 11, the tray 80 housed in the opening 78 is also translatably movable relative to the second border 243, in a radial direction to the first rotation axis R1. Thus, unlike the first embodiment, the first rotation axis R1 is not necessarily centered relative to the second border 243.

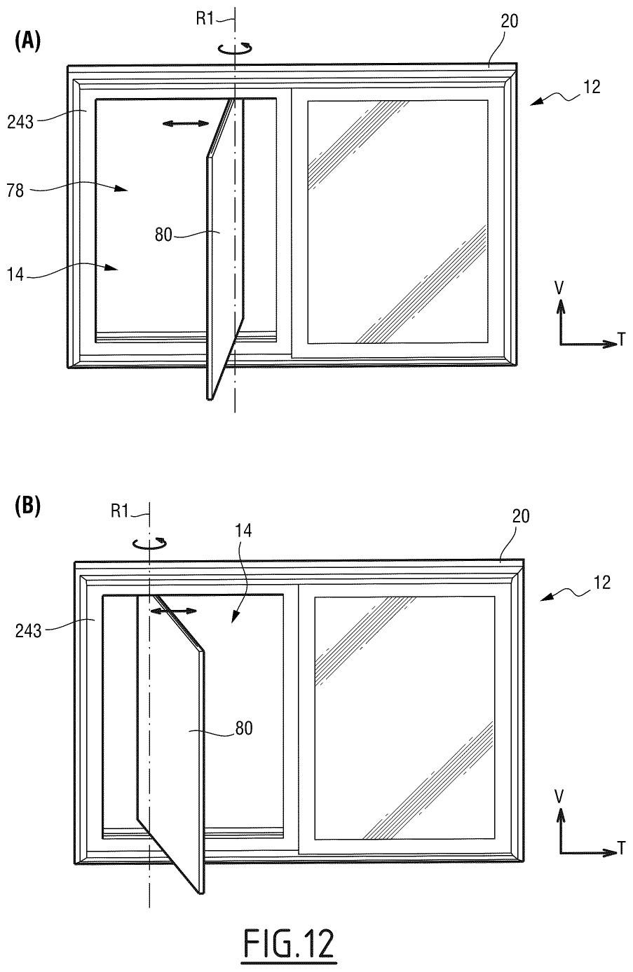

In a seventh embodiment of the invention, illustrated in FIG. 12, the tray 80 is translatably movable relative to the second border 243 in the transverse direction T. Thus, the first rotation axis R1 is not fixed relative to the second border 243, which provides more flexibility when manipulating the tray 80.

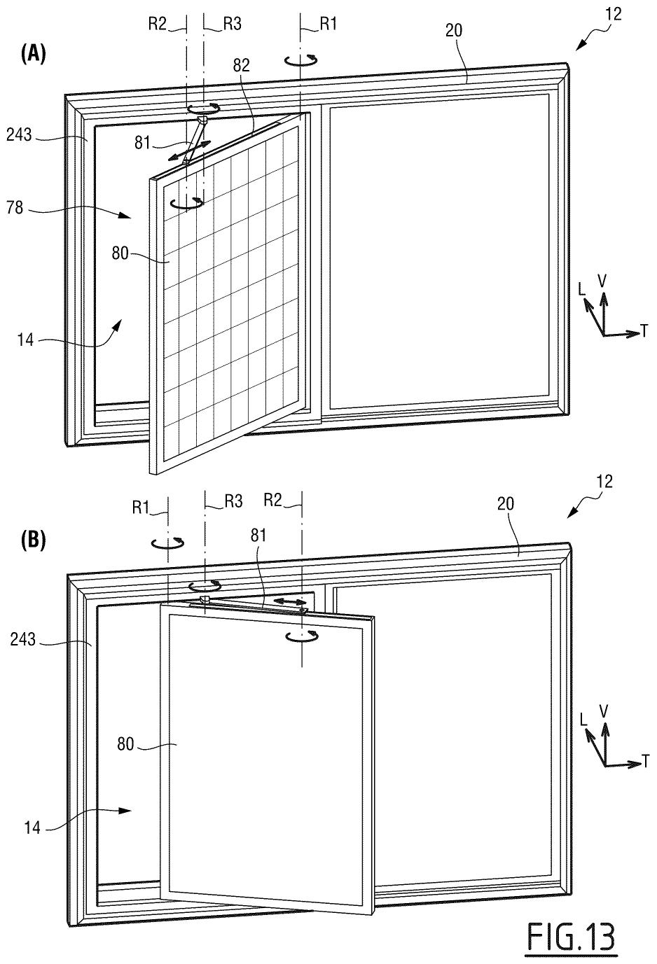

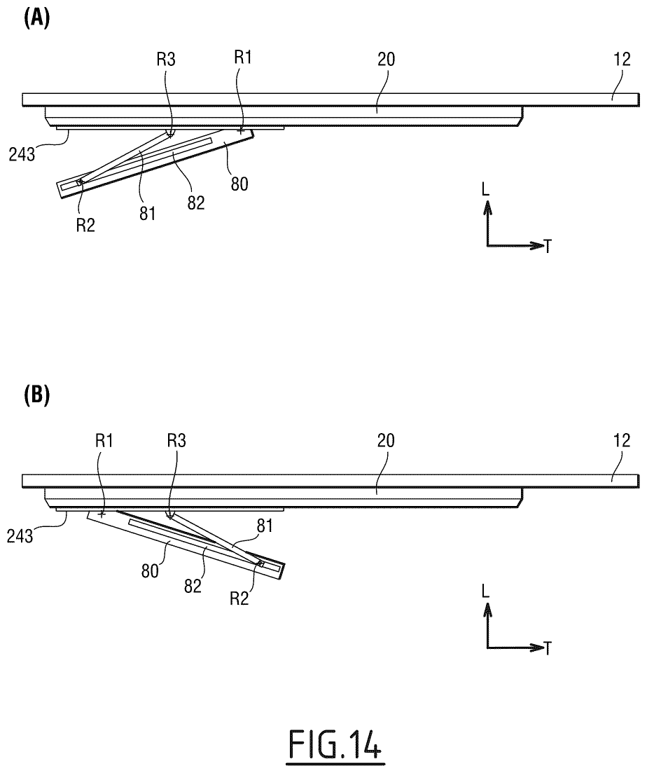

In an eighth embodiment of the invention, illustrated in FIGS. 13 and 14, the tray 80 is also translatably movable relative to the second border 243 in the transverse direction T, and the first rotation axis R1 is also located at one end of the tray 80, so that the tray 80 can pivot without crossing the opening 14. To support the weight of the tray 80 during rotation, the tray 80 in this embodiment is equipped with an arm 81 connecting the tray 80 and the second border 243. The arm 81, at a first end, is pivoting relative to the tray 80 around a second rotation axis R2 parallel to the first rotation axis R1 and sliding relative to the tray 80, by means of a slide 82 belonging to the tray 80, in a radial direction to the second rotation axis R2. The arm 81, at a second end opposite the first end, is also pivoting relative to the second border 243 around a third rotation axis R3 parallel to the first rotation axis R1. This arrangement allows the rotation of a tray 80 larger than the opening 14, and thus a gain in surface area and optimization of the invisibility of the edges.

According to an unrepresented variant of the invention applicable to all embodiments, at least one vertical edge 24b1, 24b2, or 24b3 of one of the sliding panels 221, 222, or 223 is equipped with a retractable handle. For example, the vertical edge or uptight 24a1 of the border 241 located opposite the uncovering zone 31 is equipped with a handle pivoting around an axis perpendicular to the sliding direction. This handle is integrated into this vertical edge by default, and only a tab or button of the handle protrudes from this vertical edge. When the first sliding element 221 is in the covering position of the opening 14, this vertical edge 24a1 is located on the right of the opening, seen from inside the building. It extends beyond the window opening and is invisible from inside the building at a certain distance from the window. Therefore, the handle is also invisible. By pulling, sliding, or pushing the tab, or by pressing the button, it is possible to extract the handle from the upright, by pivoting it around its pivot axis, to bring it into an active position where it protrudes from the vertical edge 24a1, where it is visible in the opening 14 from inside the building and where it can be grasped by a user to exert a pulling effort in the direction of the uncovering zone 31. Thus, the handle is discreet because it does not protrude by default from the vertical edge 24a1, so it is not visible from inside the building through the opening 14 when the first sliding element is in the covering or uncovering position of the opening 14. It remains easy to handle when the first sliding element is to be moved in translation in the transverse direction T. A retractable handle can also be integrated into each of the second and third sliding elements 222 and 223.

The invention as a whole is thus advantageous in that it allows obtaining a modular and invisible wall element from the interior space of a dwelling, thus offering optimal passage of light through the opening, while proposing a tray to be customized with any type of accessories and that can be used from the interior space of the dwelling or outside it. In particular, the fact that the border of the sliding element comprising the glazed panel is entirely outside the perimeter of the opening ensures that this panel does not limit the view to the outside from the room wherein the opening or window opens. Moreover, the invention is also advantageous in that it allows the exploitation of the entire wall inside the dwelling and also the window sill. Additionally, the invention allows adapting to any type of dwelling and dispensing with a pocket sliding door system usually used to obtain an invisible installation as proposed by the invention.

The embodiments and variants mentioned above can be combined to generate new embodiments, within the scope of the appended claims.

1. A wall element configured to be arranged around an opening formed in a wall, the wall element comprising at least one frame and at least one sliding element which is able to slide in the frame in a transverse direction, the frame comprising at least two doorframes opposite one another, each doorframe being configured to receive an edge of the at least one sliding element, the doorframes being configured so that the at least one sliding element is translatably movable between a covering position of the opening and an uncovering position of the opening, the at least one sliding element being configured to be entirely outside a perimeter of the opening in the uncovering position thereof, the doorframes each comprising an attachment support which is configured to be rigidly connected to the wall, the attachment supports being configured so that the frame extends entirely outside the perimeter of the opening of the wall, and the at least one sliding element comprising a glazed panel and a first edge and being configured so that the first edge is entirely outside the perimeter of the opening in the covering position of the first sliding element

2. The wall element according to claim 1, comprising an additional sliding element comprising at least one opening wherein a tray extends and a second border that surrounds the opening, the tray being configured to pivot around a first rotation axis relative to the second border.

3. The wall element according to claim 2, wherein the first rotation axis of the tray is fixed relative to the second border and relative to the tray.

4. The wall element according to claim 2, wherein the first rotation axis is fixed relative to the second border and the tray is translatably movable relative to the second border in a radial direction to the rotation axis.

5. The wall element according to claim 2, wherein the first rotation axis is fixed relative to the tray and mobile parallel to the transverse direction relative to the second border.

6. The wall element according to claim 5, wherein:
the first rotation axis is located at one end of the tray;
the other sliding element comprises at least one arm connecting the tray and the second border;
a first end of the arm is connected to the tray being pivoting relative to the tray around a second rotation axis parallel to the first rotation axis and translatably movable relative to the tray in a radial direction to the second rotation axis by means of a slide belonging to the tray;
a second end of the arm is connected to the second border being pivoting relative to the second border around a third rotation axis parallel to the first rotation axis.

7. The wall element according to claim 2, comprising another sliding element, the additional sliding element being a trim and the other sliding element being a shutter, the trim covering of the first sliding element and the shutter when the three sliding elements, are in their uncovering position.

8. The wall element according to claim 1, wherein the doorframes, each comprise a sliding device of the at least one sliding element, the sliding device comprising at least one raised edge wherein at least one roller is arranged.

9. The wall element according to claim 1, wherein the doorframes each comprise a sliding device of the at least one sliding element, the sliding device comprising at least one raised edge on which a roller carriage receiving one of the edges of the at least one sliding element comes into engagement.

10. The wall element according to claim 9, wherein the roller carriage comprises at least two walls delimiting at least one receiving space for the rollers and a receiving zone for one of the edges of the at least one sliding element, the receiving space and the receiving zone being strictly distinct from each other.

11. The wall element according to claim 10, wherein one of the horizontal edges of the at least one sliding element comprises at least one thinned portion configured to fit into the receiving zone of one of the horizontal edges delimited by the roller carriage, the walls of the roller carriage extending in the extension of a thickness of the sliding element.

12. The wall element according to claim 8, wherein each of the doorframes comprises at least one covering portion carrying the sliding device, the covering portion being secured to the associated attachment support by complementarity of form, the covering portion being able to slide in covering at least the attachment support

13. The wall element according to claim 1, wherein one of the edges of the at least one sliding element is equipped with a retractable handle, integrated by default into this edge, and which can be pivoted into an active position where it allows exerting a pulling effort in the transverse direction on the pivoting element.

14. An assembly comprising a wall with an opening and a wall element according to claim 1, the wall element being configured so that the frame extends around the opening of the wall.

15. The assembly according to the claim 14, wherein the attachment supports of the frame extend exclusively outside the opening of the wall.
